(19) United States
(12) Patent Application Publication
(10) Pub. No.: US 2025/0231211 A1
(43) Pub. Date: Jul. 17, 2025

(54) DIAGNOSTIC SAMPLE DRAWER MECHANISM

(71) Applicant: Center Point Bio-Tech, LLC, Las Vegas, NV (US)

(72) Inventor: Tim BAUM, Las Vegas, NV (US)

(21) Appl. No.: 18/979,303

(22) Filed: Dec. 12, 2024

Related U.S. Application Data
(60) Provisional application No. 63/620,569, filed on Jan. 12, 2024.

(51) Int. Cl. G01N 35/10; G01N 35/00

(52) U.S. Cl. CPC G01N 35/1083; G01N 35/00722

(57) ABSTRACT

A drawer apparatus for diagnostic devices can include a body configured to form a sample receiving compartment for housing a diagnostic sample. The drawer apparatus can further include a gear rack directly affixed to the body and meshing with a drive mechanism. The drawer apparatus can further include a constant force spring mechanism coupled with the gear rack. The drawer apparatus can further include a rotary damper. The drawer apparatus can further include a latch solenoid. The drawer apparatus can further include a drawer closed sensor.

### CROSS-REFERENCE TO RELATED APPLICATIONS

This application claims the benefit of, and priority to, U.S. Provisional Patent Application No. 63/620,569, filed Jan. 12, 2024, entitled “Rapid Diagnostic Testing,” the disclosure of which is incorporated by reference in its entirety.

### TECHNICAL FIELD

The present disclosure generally relates to mechanisms for handling diagnostic samples within medical and laboratory devices, and more specifically to a drawer mechanism for receiving and housing a diagnostic sample.

### BACKGROUND

Medical diagnostics play a crucial role in healthcare by enabling the detection, diagnosis, and monitoring of diseases. Diagnostic tests involve the examination of biological samples such as blood, tissue, or urine to identify disease markers. The accuracy of these tests is critical, as they directly influence treatment decisions and patient outcomes.

Despite advancements in diagnostic techniques, several challenges persist in traditional diagnostic testing methods. Primary among these is the risk of sample contamination, which can occur at multiple points during the handling process. Such contamination can lead to inaccurate test results, potentially resulting in misdiagnosis or inappropriate treatment. Moreover, conventional testing methods often involve manual processes prone to human error and operational inefficiencies. These inefficiencies can lead to delays in diagnosis and increased healthcare costs.

Additionally, increasing volume of diagnostic tests demanded by modern healthcare systems puts further strain on laboratory operations, highlighting the need for more efficient and reliable testing processes. The shortcomings of current diagnostic practices underscore a significant need for innovation in how diagnostic samples are handled and processed.

This background information is provided to reveal information believed by the applicant to be of possible relevance. No admission is necessarily intended, nor should be construed, that any of the preceding information constitutes prior art.

### SUMMARY

Briefly described, and in various aspects, the present disclosure generally relates to diagnostic devices, and more specifically to intake and analysis of samples for diagnostic testing. According to some aspects, a drawer assembly may include a body that forms a sample receiving compartment (e.g., for receiving a cartridge housing a diagnostic sample). A drive mechanism may work in conjunction with a gear rack directly affixed to the body to facilitate regulated linear motion of the drawer. The retraction force of the drawer may be uniformly modulated by a constant force spring mechanism, ensuring smooth operation. A protective casing may shield the drive mechanism from external environmental factors, thereby enhancing durability and consistent performance.

A rotary damper may dampen kinetic energy during the drawer's opening and closing movements. A latch solenoid may engage with the drawer to prevent unintended opening by maintaining the drawer in a secure closed state. A positional state of the drawer (e.g., whether open or closed) may be monitored by a drawer closed sensor. An electronic control unit may be operatively connected to the latch solenoid, rotary damper, and/or drawer closed sensor. For example, the door closed sensor may transmit the positional state to the electronic control unit of a diagnostic device and/or verify containment of the diagnostic sample. Furthermore, the electronic control unit may coordinate opening and closing the drawer, tailoring movements to the specific needs of the diagnostic procedures.

According to some aspects, a diagnostic device may include a memory and at least one computing device in communication with the memory. The at least one computing device may be configured to open a drawer of the diagnostic device to receive a cartridge housing a diagnostic sample. A retraction force of the drawer may be modulated by using a constant force spring to retract the drawer into the diagnostic device. The constant force spring mechanism may be enclosed within a casing affixed to the body. The casing may protect the spring mechanism from external environmental factors. Furthermore, the opening and closing of the drawer may be based on one or more programmed operational parameters. A linear guide may facilitate bi-directional movement of the drawer along a defined pathway. Containment of the cartridge within the diagnostic device may be verified based on a sensor and the drawer may be secured into the diagnostic device using a latch solenoid.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an exemplary diagnostic device, according to various aspects of the present disclosure;

FIG. 2 illustrates an exemplary drawer apparatus, according to various aspects of the present disclosure;

FIG. 3 illustrates an exemplary drawer apparatus, according to various aspects of the present disclosure;

FIG. 4 illustrates exemplary components for a drawer apparatus, according to various aspects of the present disclosure;

FIG. 5 illustrates an interior of an exemplary diagnostic device, according to various aspects of the present disclosure;

FIG. 6 illustrates an exemplary process performed by a diagnostic system according to various aspects of the present disclosure;

FIG. 7 illustrates an exemplary diagrammatic representation of a machine in the form of a computer system according to various aspects of the present disclosure; and

FIG. 8 illustrates a schematic of an exemplary device according to various aspects of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. As used herein, the terms “machine,” “computer,” “server,” and “work station” are not limited to a device with a single processor, but may encompass multiple devices (e.g., computers) linked in a system, devices with multiple processors, special purpose devices, devices with various peripherals and input and output devices, software acting as a computer or server, and combinations of the above.

The present disclosure provides a sophisticated drawer apparatus for use in diagnostic devices, designed to enhance the secure housing and smooth retrieval of diagnostic samples. The drawer apparatus can utilize a gear rack directly affixed to the body and meshing with a drive mechanism, a constant force spring mechanism, a rotary damper, a latch solenoid, and a drawer closed sensor. These components work in unison to ensure the drawer moves linearly with precision, securely locks in place, and provides reliable feedback on its positional state. An electronic control unit coordinates these elements, facilitating the efficient and secure handling of samples within the diagnostic device.

The drawer apparatus may provide controlled and reliable operation for the secure containment of diagnostic samples. The gear rack and drive mechanism may ensure smooth linear motion. The constant force spring and rotary damper may regulate the movement, preventing abrupt motions that could compromise sample integrity. The latch solenoid may ensure the drawer remains securely closed during operation, and the drawer closed sensor may provide real-time feedback on the drawer's status. The drawer apparatus may minimize human interaction with diagnostic samples, reducing the risk of contamination. Moreover, the drawer apparatus may facilitate improvement in the accuracy in the diagnostic testing. The drawer apparatus provides a significant improvement over conventional diagnostic testing equipment by, for example, enhancing the reliability, safety, and efficiency of diagnostic procedures within a diagnostic device.

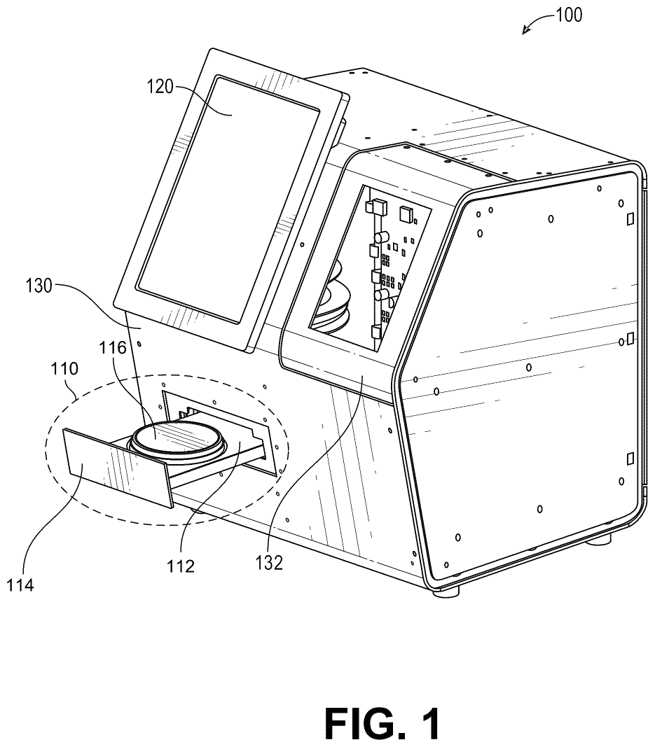

As illustrated in FIG. 1, an exemplary diagnostic device 100 may include a drawer apparatus 110, a display 120, a housing 130, and a door 132. Diagnostic device 100 can be used for testing biological samples to accurately analyze and evaluate specimens such as blood, urine, tissue, and other bodily fluids. Diagnostic device 100 can detect, diagnose, and monitor various medical conditions and diseases. The diagnostic device 100 can employ a range of technologies, including biochemical assays, immunoassays, molecular diagnostics, and imaging techniques, to provide precise and timely information about the presence of pathogens, biomarkers, genetic mutations, or other indicators of health and disease. By facilitating rapid and reliable testing, diagnostic devices play a crucial role in guiding clinical decision-making, enabling early detection and intervention, improving patient outcomes, and supporting ongoing medical research and public health efforts.

Diagnostic device 100 may include one or more automated sample handling systems. The automated sample handling system(s) may minimize the risk of sample contamination by handling samples in a sterile environment, reducing human contact and lowering the possibility of introducing contaminants. The automated sample handling system(s) may improve safety and repeatability and reliability of test results by transferring and positioning samples within the diagnostic device 100.

Moreover, the diagnostic device 100 process a large number of samples quickly without compromising accuracy. For example, high throughput capability of the diagnostic device 100 may be beneficial in situations where timely analysis of large volumes of samples is critical. The diagnostic device 100 may utilize parallel processing to run multiple assays simultaneously. Additionally, the diagnostic device 100 may use rapid thermal cycling to speed up molecular diagnostic tests such as PCR (Polymerase Chain Reaction), thereby reducing the overall time from sample intake to result delivery.

The diagnostic device 100 may employ software including one or more algorithms to interpret biochemical signals from the assays. For example, machine learning techniques may provide continual improvement (e.g., diagnostic accuracy, early detection of diseases, and improved treatment outcomes) by learning from historical data to better identify patterns and anomalies in samples.

The diagnostic device 100 may include an imaging system that provides high-resolution images for detailed analysis. The imaging system may utilize optical and/or electron microscopy for a variety of diagnostic procedures, e.g., routine blood tests or histopathological examinations. Moreover, the imaging system may detect minute morphological changes in cells and tissues that often indicate the early stages of disease, providing clinicians with critical diagnostic information.

Furthermore, the diagnostic device 100 may include a communication system that securely transmits data to healthcare providers for coordinating care and managing patient treatment plans. For example, the communication system may quickly and securely share the results of diagnostic tests with relevant medical professionals, enabling faster clinical decision-making. The communication system may ensure any communications are compliant with healthcare industry standards for data security, ensuring patient confidentiality is maintained.

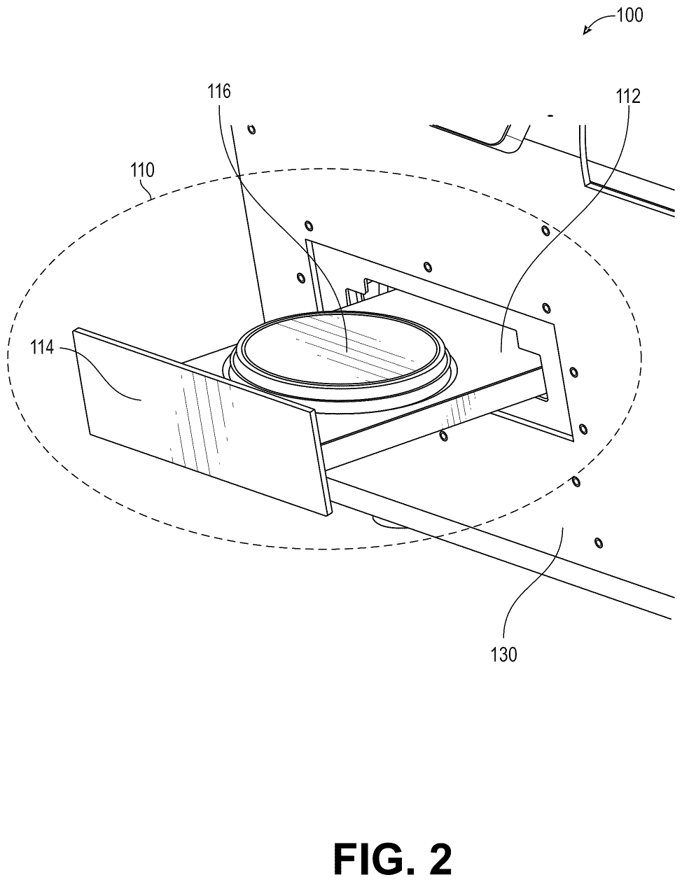

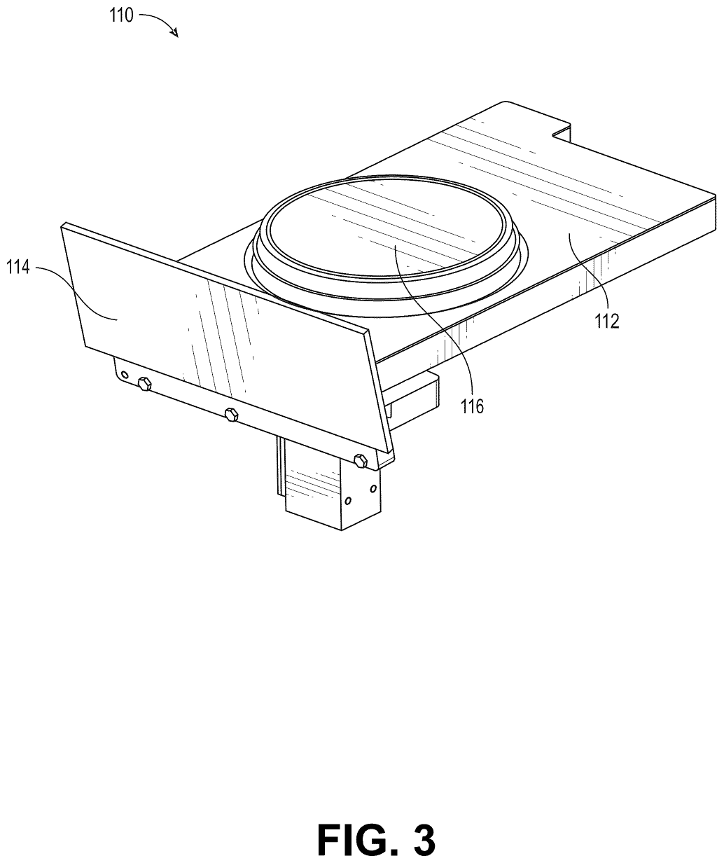

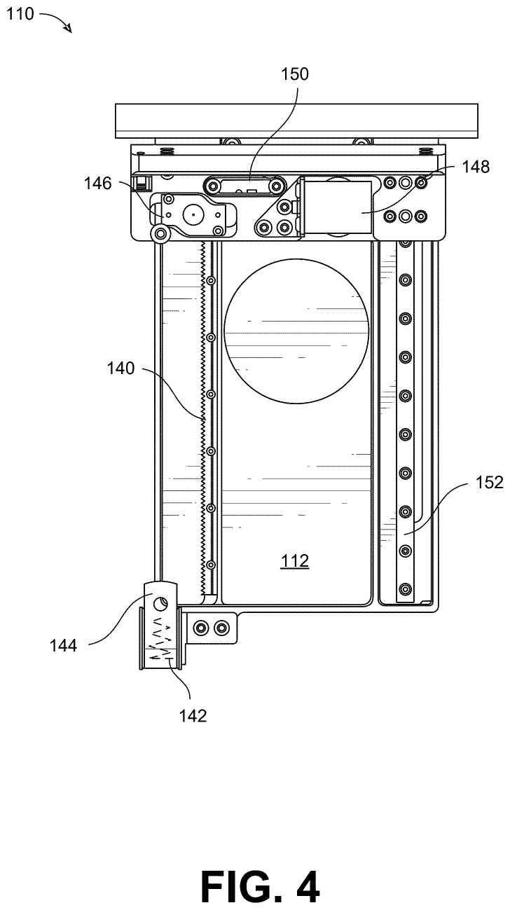

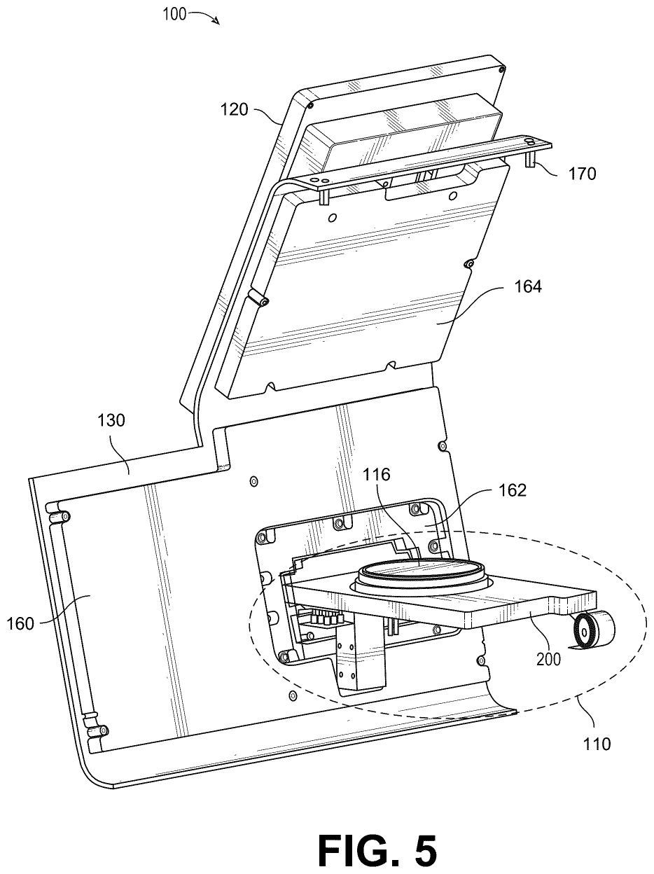

As illustrated in FIG. 1, FIG. 2, FIG. 3, FIG. 4, and FIG. 5, the drawer apparatus 110 may be integrated with diagnostic device 100. The drawer apparatus 110 may include a body 112, forming a sample receiving compartment that may receive biological samples (e.g., stored on or within cartridge 116). One or more dimensions of the sample receiving compartment may be based on accommodation of standard-sized petri dishes and other sample containers (e.g., cartridge 116). Moreover, the body 112 of the drawer apparatus 110 may provide a stable and safe environment for the cartridge 116, ensuring the one or more samples stored by the cartridge 116 remain uncontaminated and intact throughout the diagnostic process.

The drawer apparatus 110 may include a cover 114 attached to the body 112. The cover 114 may form a seal with the diagnostic device 100 when the drawer apparatus 110 is in a closed position. Moreover, the cover 114 may include a gasket or other sealing mechanism made of flexible, durable materials (e.g., silicone), which may conform to the body 112 and ensure a seal that prevents ingress of contaminants and the egress of controlled atmosphere.

The body 112 and/or the cover 114 may be constructed from durable materials such as stainless steel, polycarbonate, high-impact polystyrene, acrylic, aluminum, or any other suitable metal or plastic. The body 112 and/or the cover 114 may offer protection against physical damage and environmental factors, facilitating placement and retrieval of diagnostic samples. The compartmentalized structure of the drawer apparatus 110 may maintain sample integrity and ensure accurate test results, enhancing the overall functionality and reliability of the diagnostic device 100.

The cartridge 116 may be disposable or reusable, depending on, for example, specific requirements of the diagnostic process or operational standards of a healthcare facility. In some aspects, cartridge 116 may be a petri dish that can house a variety of biological samples for testing. Examples of the biological samples may include but are not limited to blood samples, urine samples, tissue samples, saliva samples, fecal samples, spinal fluid, sputum samples, cultures, and swabs. The cartridge 116 may be comprised of materials that do not interact chemically with the samples (e.g., glass, coated metals, or specialized plastics) to prevent any potential sample alteration or degradation. Additionally, the materials used in the construction of cartridge 116 may be durable and resistant to temperature variations and chemical exposures, thereby accommodating rigorous environmental controls of laboratory and medical settings. The materials may be transparent to allow for optical and other forms of testing directly on the samples stored within the cartridge, facilitating real-time monitoring and analysis without the need for sample transfer, preserving sample integrity, and reducing contamination risks. Each cartridge 116 may be equipped with a smart-label or barcode that allows for automatic identification and tracking by the electronic control unit of the diagnostic device 100. For example, the smart label or barcode may link every sample to specific patient data and test requirements.

The cartridge 116 may be sized to fit within the confines of the body 112, maximizing space utilization while ensuring easy placement and retrieval. Moreover, cartridge 116 may interface with the drawer apparatus 110 of the diagnostic device 100, facilitating secure storage and efficient processing of diagnostic samples. For example, a precision fit of the cartridge 116 within the drawer apparatus 110 may be facilitated by guide rails and a soft-locking mechanism to provide a secure and easily reversible insertion and removal process.

The diagnostic device 100 may perform a wide range of tests on biological samples contained within the cartridge 116. The tests may include but are not limited to biochemical assays for enzyme activities and metabolite concentrations, immunoassays such as ELISA for detecting antibodies and antigens, and molecular diagnostics, including PCR for genetic analysis and pathogen detection. Additionally, the diagnostic device 100 may support cytological and histological examinations using advanced imaging techniques to observe morphological changes in cells and tissues to, for example, detect cancerous transformations or infectious agents. The transparent nature of cartridge 116 may allow for real-time optical analysis, such as spectrophotometry and fluorescence microscopy, providing immediate and precise diagnostics critical for effective disease management and treatment planning.

The drawer apparatus 110 of diagnostic device 100 may include several features for handling and analysis of biological samples, including maintaining the structural integrity of sensitive samples such as tissue biopsies. For example, the drawer apparatus 110 may include a linear actuation system for smooth and controlled movement of the drawer apparatus 110. The linear actuation system may include a gear rack 140 and pinion mechanism that prevents abrupt starts and stops that can disrupt sample integrity or cause spillage. A pinion (e.g., a gear) may engage with the gear rack 140 (e.g., a linear gear rack) that is fixed in place. As the pinion rotates, it may move along the gear rack 140, thereby pulling or pushing the drawer in a linear direction. The linear actuation system may include one or more electronic sensors (e.g., drawer sensor 150) that provide real-time feedback on a position of the drawer. The electronic sensors may detect and transmit a real-time location of the drawer, allowing a control unit to make adjustments if any deviation from the expected path is detected.

The linear actuation system may be made from hardened steel or a high-strength polymer composite to withstand repetitive use under varying environmental conditions without degrading. Moreover, the linear actuation system may include a series of bearings along the track. The bearings may reduce friction as the drawer slides, making the movement smoother and reducing wear on the mechanical components. Through the use of tight tolerances, the linear actuation system may facilitate consistent operational motion of the drawer apparatus 110 and reduce mechanical backlash that could otherwise lead to inaccuracies in drawer positioning. For example, the linear actuation system may allow the drawer to open and close to the exact required position every time, which may facilitate automated sample processing where even small deviations can lead to significant errors in handling.

According to some aspects, the drawer apparatus 110 may include a locking mechanism to enhance the safety and reliability of sample handling. The locking mechanism may be controlled by a latch solenoid (e.g., latch solenoid 148). Latch solenoid 148 may be an electromechanical lock that is activated or deactivated through electrical signals controlled by electronic control unit. The latch solenoid 148 may be de-energized to unlock the drawer, retracting the rod and allowing the drawer to open smoothly for access to the samples. For example, when the drawer reaches a closed position, the latch solenoid 148 may be energized, causing a metal rod or pin to extend into a receiving hole or notch in the drawer, and effectively locking the drawer in place. The latch solenoid 148 may secure the contents inside the drawer apparatus 110 by preventing the drawer from being opened accidentally or due to vibrations or other external forces.

According to some aspects, the internal environment of the drawer apparatus 110 may be controlled to ensure optimal conditions for the preservation and analysis of biological samples. For example, environmental parameters (e.g., temperature, humidity, atmospheric composition, etc.) may be regulated depending on sample requirements. The drawer apparatus 110 may include one or more sensors that monitor the environmental parameters continuously and relay the data to a microcontroller. The drawer apparatus may further include one or more heating elements, cooling systems, or dehumidifiers, which may be adjusted based on the sensor data. For instance, a thermoelectric cooler may be activated to maintain a low temperature for biochemical samples, while a small humidifier may adjust the moisture level for tissue samples. Precise control of the internal environment of the drawer apparatus 110 may prevent sample degradation and ensure reliable diagnostic results, tailored to the specific needs of different types of biological specimens.

According to some aspects, the drawer apparatus 110 may include a modular internal layout that can be customized according to the types of samples being analyzed. For example, the drawer apparatus 110 may include one or more adjustable compartments that can accommodate different sample container sizes, e.g., petri dishes or biopsy trays. This flexibility may maximize use of space within the drawer and facilitate organization of samples

Furthermore, the drawer apparatus 110 may integrate with the electronic control unit of the diagnostic device 100. For example, interactions (e.g., sample placement and sample retrieval operations) with the drawer may be recorded, providing a traceable audit trail for compliance with laboratory standards and regulations. Moreover, procedures involving the drawer apparatus 110 may be documented and/or reviewed for quality control purposes. Diagnostic device 100 may comprise a user interface, e.g., a display 120. The display 120 on the diagnostic device 100 can serve as a user interface, providing users with essential information and control options during the diagnostic process. For example, the user interface may guide users through the diagnostic process, including offering troubleshooting assistance and procedural guidance. Moreover, the user interface may provide real-time diagnostics support to make advanced diagnostic capabilities accessible to a broader range of laboratory technicians and healthcare providers.

According to some aspects, the display 120 may be a touch display, allowing users to interact directly with the diagnostic device 100. The display 120 can allow users to navigate menus, select tests, and input data with ease and efficiency. The display 120 can show real-time data, results, and status updates, ensuring users have immediate access to information. Display 120 can be of various sizes and resolutions to accommodate user needs and preferences. According to some aspects, the display 120 may include color or monochrome options for different applications, and may incorporate features including gesture recognition or voice command support. Furthermore, the display 120 may include different levels of touch sensitivity, offering options like multi-touch capability for more advanced control and user experience.

The housing 130 may provide an enclosure for the diagnostic device 100. Moreover, the housing 130 may protect and stabilize the components and mechanisms within the diagnostic device 100. The housing 130 may be constructed from materials such as reinforced polymers or aluminum alloys. The materials of the housing 130 may be selected for their durability and resistance to environmental factors such as temperature variations, humidity, and electromagnetic interference. Furthermore, the housing 130 may include thermal insulation to mitigate any thermal effects on the samples and/or electronic components. Moreover, the housing 130 may comprise sound-dampening materials to reduce operational noise.

The door 132 on the diagnostic device 100 may provide secure and controlled access to the interior of the diagnostic device 100, where diagnostic components and samples are housed. The door 132 may provide access to the diagnostic components inside diagnostic device 100 for maintenance or other times where human intervention within the diagnostic testing is necessary. Moreover, the door 132 may seal when closed, preventing contamination and protecting sensitive components from external factors such as dust and moisture. According to some aspects, the door 132 may feature a window, allowing users to visually monitor the internal processes without opening the door, thereby maintaining the sealed environment. The door 132 may ensure that samples remain uncontaminated and that users can efficiently manage diagnostic procedures, enhancing the functionality and reliability of the diagnostic device 100.

As illustrated in FIG. 4 (e.g., showing a bottom view of the drawer apparatus 110), the drawer apparatus 110 may include a gear rack 140. A constant force spring mechanism 142 may be coupled with the gear rack 140 to uniformly modulate a retraction force of the drawer apparatus 110. For example, the constant force spring mechanism 142 may ensure that the drawer can be smoothly and consistently retracted into the housing 130 when subjected to varying loads. According to some aspects, the constant force spring mechanism 142 may be enclosed within a casing 144 affixed to the body 112, protecting the constant force spring mechanism 142 from external environmental factors that could affect performance of the constant force spring mechanism 142.

The drawer apparatus 110 may include a rotary damper 146. Rotary damper 146 may dampen kinetic energy associated with the movement of the drawer apparatus 110, ensuring smooth and controlled operation. For example, the rotary damper 146 may absorb excess energy, preventing abrupt stops or movements that could damage the sample (e.g., contained by cartridge 116) or the drawer apparatus 110. According to some aspects, the rotary damper 146 may be adjustable to allow for customization of the damping effect associated with the rotary damper 146.

The drawer apparatus 110 may include a latch solenoid 148 to selectively maintain the drawer apparatus 110 in a secure closed state within the diagnostic device 100. The latch solenoid 148 may be controlled by an electronic control unit, which may coordinate the opening and closing of the drawer apparatus 110. For example, the latch solenoid 148 may engage with a corresponding latch mechanism on the diagnostic device 100, ensuring a secure closure.

According to some aspects, the drawer apparatus 110 may include a drawer sensor 150. In some aspects, the drawer sensor 150 may be a magnetic sensor that detects the presence of a magnet on the drawer, indicating a position of the drawer. Moreover, the drawer sensor 150 may be used to verify the containment of the diagnostic sample. For example, the drawer sensor 150 may transmit a positional state of the drawer to the diagnostic device (e.g., electronic control unit), which may provide feedback to the user regarding the status of the sample.

According to some aspects, the drawer apparatus 110 may include a linear guide 152. The linear guide 152 may maintain alignment and prevent lateral movement, thereby contributing to the accuracy and reliability of the sample handling process. The linear guide 152 may support and stabilize the drawer's movement, reducing wear and tear on the components and enhancing the overall smoothness of operation. In some aspects, the linear guide 152 may ensure that the drawer apparatus 110 moves along a defined pathway with minimal friction and maximal precision.

An electronic control unit (e.g., computer system 700 or computing device 800) may be operatively connected to the latch solenoid 204, rotary damper 203, and drawer closed sensor 205. The electronic control unit (ECU) may coordinate the opening and closing of the drawer, ensuring that it is done smoothly and securely. In some aspects, the ECU may programmable, allowing for customization of the operational parameters of the drawer apparatus.

The ECU may coordinate one or more mechanical components of the drawer apparatus 110. For example, the ECU may be programmed to manage the sequence of drawer movements in response to user commands or automated schedules. The ECU may control the drive mechanism, which may interact with the gear rack 140 to facilitate smooth and regulated linear motion of the drawer. By monitoring inputs from the drawer sensor 150, the ECU may determine the drawer's position, whether fully opened or securely closed, and make real-time adjustments to the movement parameters to prevent abrupt stops or unintended openings that might compromise the integrity of the samples. Additionally, the ECU may be responsible for engaging the latch solenoid 148, which may lock the drawer in a closed position to ensure secure containment of the diagnostic samples during and after the handling processes.

Furthermore, the ECU may interface with one or more other sensors and actuators within the diagnostic device 100. For example, the ECU may process data from environmental sensors that monitor conditions such as temperature and humidity within the sample storage areas, adjusting internal controls to maintain optimal conditions for sample preservation. The ECU may control the rotary damper 146 to modulate the kinetic energy during the drawer's opening and closing, minimizing mechanical wear and noise and contributing to a more stable operating environment. Through integrated software, the ECU may execute diagnostic algorithms that assist in the preliminary analysis of the samples based on the data gathered during the handling process. The ECU may allow for initial assessments to be made quickly, enhancing the workflow in laboratory settings where time and accuracy are crucial. The functionality of the ECU may automate sample handling in the diagnostic device 100, significantly reducing the potential for human error and increasing the throughput of diagnostic tests conducted in medical and research laboratories.

FIG. 5 shows an interior view of diagnostic device 100. Diagnostic device 100 may house drawer apparatus 110 within its housing 130. According to some aspects, the body 112 of diagnostic device 100 may include display 120, insulation 160, insulation 162, insulation 164, housing 130, and standoffs 170. The display 120 may serve as a user interface, providing users with information and control options. According to some aspects, display 120 may be a touch display, enabling direct interaction and easy navigation through menus, test selection, and data input. Moreover, display 120 may show real-time data and status updates, providing a user with access to information. Display 120 may include dimensions and/or resolutions to suit user needs, e.g., with options for color or monochrome displays. Some aspects of the display 120 may include features such as gesture recognition or voice command support for enhanced user interaction. Additionally, different touch sensitivity levels, including multi-touch capability, may provide the display 1120 with advanced control options.

The insulation (e.g., insulation 160, insulation 162, or insulation 164) may protect internal components from external environmental factors such as temperature fluctuations, moisture, and electrical interference. According to some aspects, insulation 160, insulation 162, and/or insulation 164 foam may be comprised of one or more of fiberglass, polyurethane, mineral wool, reflective insulation, cellulose, or any other suitable material. Moreover, the insulation (e.g., insulation 160, insulation 162, or insulation 164) may facilitate maintenance of a stable internal environment for the accurate and reliable operation of the diagnostic device 100. Furthermore, the insulation (e.g., insulation 160, insulation 162, or insulation 164) may facilitate the incubation of diagnostic samples that can be housed within diagnostic device 100. For example, the insulation may prevent heat loss or gain, ensuring that the diagnostic device 100 operates within optimal temperature ranges. Additionally, the insulation may contribute to soundproofing, reducing noise emitted by the device during operation.

The housing 130 of diagnostic device 100 may serve as a protective and aesthetic covering, enclosing and safeguarding the internal components of the diagnostic device 100. Moreover, housing 130 may enhance durability and resistance to external factors such as impact, dust, and moisture. The housing 130 may be comprised one or more materials, including but not limited to plastic, metal, rubber, silicone, glass, composite, or any other suitable material.

According to some aspects, diagnostic device 100 may utilize one or more standoffs 170. The standoffs 170 may maintain space within the diagnostic device 100 and/or secure and hold electronic components (e.g., display 120. In some aspects, the standoffs 170 may be round or hex standoffs.

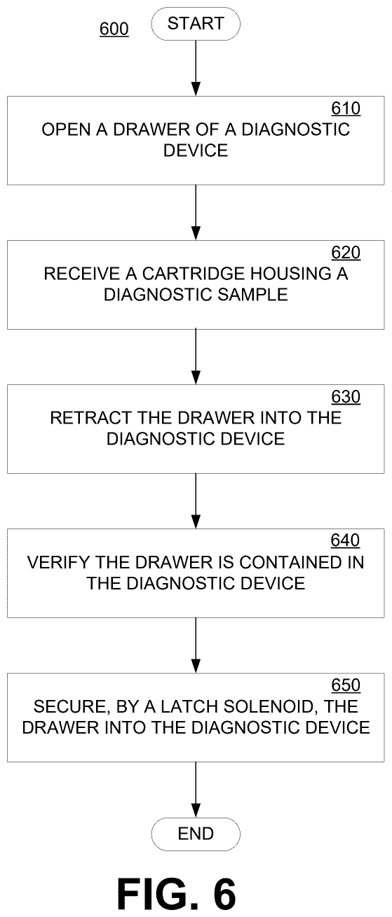

With reference to FIG. 6, shown is a flow chart of a process 600 according to various aspects of the present disclosure. The process 600 or one or more steps thereof may be performed by the diagnostic device 100, drawer apparatus 110, or any of the devices illustrated in FIGS. 1-6 or FIGS. 7-8.

At box 610, the process 600 may include opening a drawer apparatus 110 of a diagnostic device 100. The diagnostic device 100 may control the drawer apparatus 110 using an ECU, which may coordinate the various components of the drawer apparatus 110 to ensure smooth and reliable operation. For example, when a user initiates the opening of the drawer via display 120, the ECU may send signals to the latch solenoid 148 to disengage, allowing the drawer to open. The ECU may activate the drive mechanism simultaneously or consecutively, which may engage with the gear rack 140 to induce a regulated linear motion of the drawer. The constant force spring mechanism 142 may provide a uniform retraction force, ensuring that the drawer moves smoothly and consistently. The rotary damper 146 may control the kinetic energy associated with the movement, ensuring that the drawer opens in a controlled manner without any abrupt movements. The drawer apparatus 110 may include a linear guide that ensures the drawer maintains its trajectory without any lateral shifts. A gear rack 140 may translate the rotational motion of the drive mechanism into the linear movement of the drawer. The diagnostic device 100 may monitor the position of the drawer sensor 150, ensuring that the drawer is opened securely and remains in the open position until manually closed by the user.

At box 620, the process 600 may include receiving a cartridge housing a diagnostic sample. The cartridge may be received in a compartment 210 of drawer apparatus 110 configured for securing diagnostic samples ensuring their integrity and preventing contamination. When a cartridge is inserted into the compartment 210, the cartridge may be guided by the design of the compartment 210 to fit securely and align properly. The compartment 210 may provide a stable environment for the cartridge, protecting it from external factors that could affect the sample. Additionally, the compartment 210 may use locking mechanisms or sensors to ensure that the cartridge is securely in place and ready for analysis. The process 600 may ensure that the diagnostic sample is safely and securely housed within the drawer apparatus 110, ready for further processing and analysis.

At box 630, the process 600 may include retracting the drawer apparatus 110 into diagnostic device 100. The retraction force may be modulated using a constant force spring mechanism 201, ensuring smooth and consistent movement of the drawer apparatus 110 during the retraction process. The constant force spring mechanism 201 may apply a uniform force over the entire length of the retraction, preventing sudden changes in force that may lead to jerky or uneven movement. This smooth operation may facilitate safe handling of diagnostic samples housed within the drawer apparatus 110 by reducing the risk of sample spillage or damage. Additionally, the constant force spring mechanism 201 may prolong the lifespan of the drawer apparatus 110 components by minimizing wear and tear caused by abrupt movements.

At box 640, the process 600 may include verifying the cartridge is properly contained inside diagnostic device 100. The diagnostic device 100 may verify the status of the cartridge using drawer closed sensor 205, which may detect whether the cartridge is securely in place. This verification process may prevent the diagnostic device 100 from starting any diagnostic procedures if the cartridge is not properly contained. If the drawer closed sensor 205 detects that the cartridge is not properly contained, the diagnostic device 100 may alert the user or prevent the diagnostic device 100 from proceeding until the issue is resolved. Moreover, the verification process may ensure that the diagnostic system operates safely and efficiently, reducing the risk of sample contamination or damage.

At box 650, the process 600 may include securing the drawer apparatus 110 into the diagnostic device 100. The drawer apparatus 110 may be secured using a latch solenoid 204. When the drawer is fully retracted into the system, the latch solenoid 204 may be engaged to lock the drawer in place. Thereby the drawer may remain securely closed, preventing accidental opening and ensuring the integrity of the samples housed within. The latch solenoid 204 may be controlled by the ECU, which coordinates the locking and unlocking of the drawer. Securing the drawer apparatus 110 into the diagnostic device 100 may provide a reliable and safe mechanism for containing and protecting diagnostic samples, enhancing the overall functionality and efficiency of the diagnostic device 100.

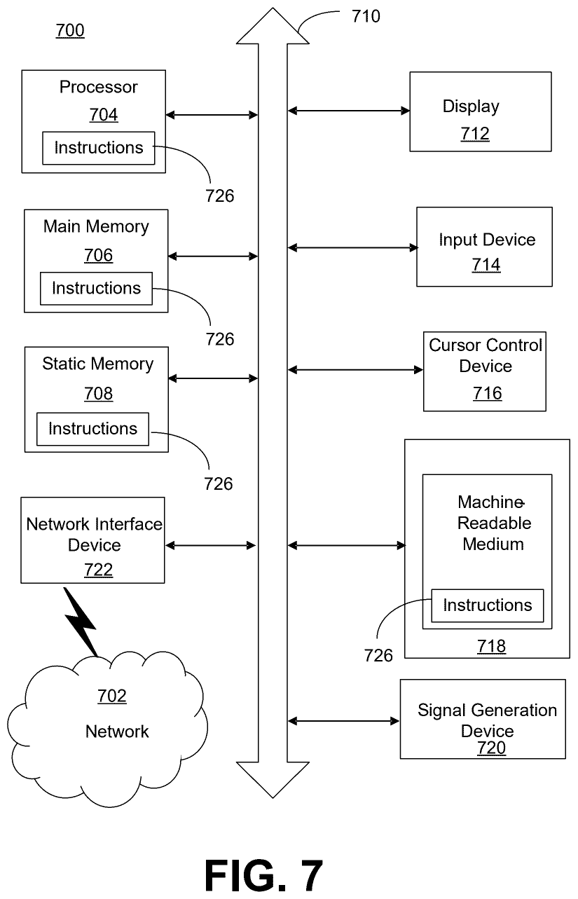

FIG. 7 depicts an exemplary diagrammatic representation of a machine in the form of a computer system 700 within which a set of instructions, when executed, may cause the machine to perform any one or more of the methods described above. One or more instances of the machine can operate, for example, as a computing device, processor, controller, or other device associated with or illustrated in FIGS. 1-6 and 8. In some examples, the machine may be connected (e.g., using a network 702) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 700 may include a processor (or controller) 704 (e.g., a central processing unit (CPU)), a graphics processing unit (GPU, or both), a main memory 706 and a static memory 708, which communicate with each other via a bus 710. The computer system 700 may further include a display unit 712 (e.g., a liquid crystal display (LCD), a flat panel, or a solid-state display). Computer system 700 may include an input device 714 (e.g., a keyboard), a cursor control device 716 (e.g., a mouse), a disk drive unit 718, a signal generation device 720 (e.g., a speaker or remote control) and a network interface device 722. In distributed environments, the examples described in the subject disclosure can be adapted to utilize multiple display units 712 controlled by two or more computer systems 700. In this configuration, presentations described by the subject disclosure may in part be shown in a first of display units 712, while the remaining portion is presented in a second of display units 712.

The disk drive unit 718 may include a tangible computer-readable storage medium on which is stored one or more sets of instructions (e.g., instructions 726) embodying any one or more of the methods or functions described herein, including those methods illustrated above. Instructions 726 may also reside, completely or at least partially, within main memory 706, static memory 708, or within processor 704 during execution thereof by the computer system 700. Main memory 706 and processor 704 also may constitute tangible computer-readable storage media.

While examples of a system for handling and transporting diagnostic samples have been described in connection with various computing devices/processors, the underlying concepts may be applied to any computing device, processor, or system capable of handling and transporting diagnostic samples. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for handling and transporting diagnostic samples. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with handling and transporting diagnostic samples as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing diagnostic testing as described herein. When implemented on a general-purpose processor, the program code combines with the processor to provide a unique device that operates to invoke the functionality of handling and transporting diagnostic samples.

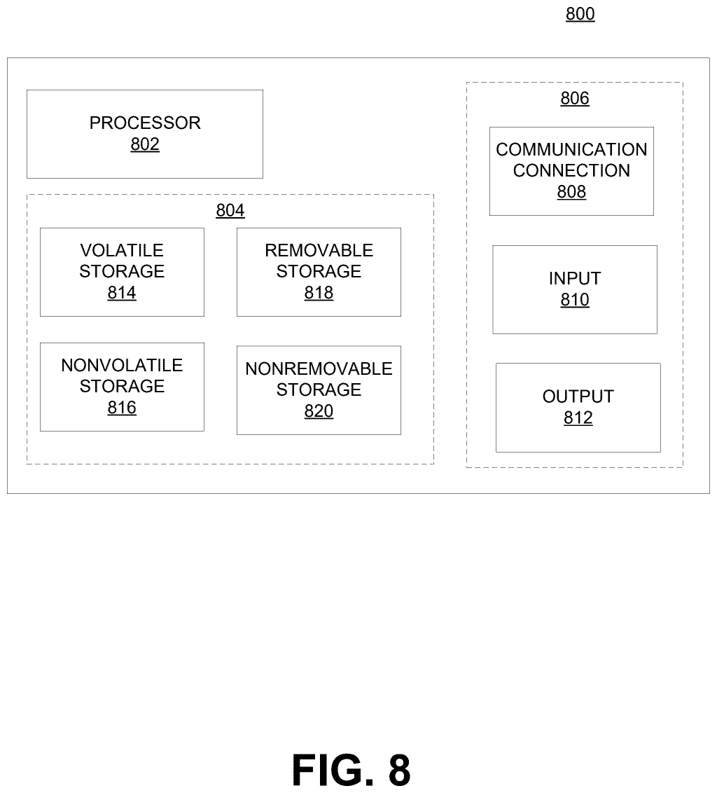

FIG. 8 is a block diagram of a computing device 800 that may be connected to or comprise a component of one or more devices of FIGS. 1-7. Computing device 800 may comprise hardware or a combination of hardware and software. The functionality to handle and transport diagnostic samples may reside in one or a combination of computing devices 800. Computing device 800 depicted in FIG. 8 may represent or perform functionality of an appropriate computing device 800, or a combination of computing devices 800, such as, for example, a component or various components of a diagnostic system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 8 is exemplary and not intended to imply a limitation to a specific example or configuration. Thus, computing device 800 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 800 may comprise a processor 802 and a memory 804 coupled to processor 802. Memory 804 may contain executable instructions that, when executed by processor 802, cause processor 802 to effectuate operations associated with a diagnostic system.

As evident from the description herein, computing device 800 is not to be construed as software per se.

In addition to processor 802 and memory 804, computing device 800 may include an input/output system 806. Processor 802, memory 804, and input/output system 806 may be coupled together (coupling not shown in FIG. 8) to allow communications between them. Each portion of computing device 800 may comprise circuitry for performing functions associated with each respective portion. Thus, each portion may comprise hardware, or a combination of hardware and software. Accordingly, each portion of computing device 800 is not to be construed as software per se. Input/output system 806 may be capable of receiving or providing information from or to a communications device or other network entities configured for handling and transporting diagnostic samples. For example, input/output system 806 may include a wireless communication (e.g., 3G/4G/5G/GPS) card. Input/output system 806 may be capable of receiving or sending video information, audio information, control information, image information, data, or any combination thereof. Input/output system 806 may be capable of transferring information with computing device 800. In various configurations, input/output system 806 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 806 may comprise a Wi-Fi finder, a two-way GPS chipset or equivalent, or the like, or a combination thereof.

Input/output system 806 of computing device 800 also may contain a communication connection 808 that allows computing device 800 to communicate with other devices, network entities, or the like. Communication connection 808 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 806 also may include an input device 810 such as keyboard, mouse, pen, voice input device, or touch input device. Input/output system 806 may also include an output device 812, such as a display, speakers, or a printer.

Processor 802 may be capable of performing functions associated with a diagnostic system, such as functions for handling and transporting diagnostic samples, as described herein. For example, processor 802 may be capable of, in conjunction with any other portion of computing device 800, gripping and manipulating petri dishes containing diagnostic samples within a diagnostic device, as described herein.

Memory 804 of computing device 800 may comprise a storage medium having a concrete, tangible, physical structure. As is known, a signal does not have a concrete, tangible, physical structure. Memory 804, as well as any computer-readable storage medium described herein, is not to be construed as a signal. Memory 804, as well as any computer-readable storage medium described herein, is not to be construed as a transient signal. Memory 804, as well as any computer-readable storage medium described herein, is not to be construed as a propagating signal. Memory 804, as well as any computer-readable storage medium described herein, is to be construed as an article of manufacture.

Memory 804 may store any information utilized in conjunction with diagnostic testing. Depending upon the exact configuration or type of processor, memory 804 may include a volatile storage 814 (such as some types of RAM), a nonvolatile storage 816 (such as ROM, flash memory), or a combination thereof. Memory 804 may include additional storage (e.g., a removable storage 818 or a non-removable storage 820) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 800. Memory 804 may comprise executable instructions that, when executed by processor 802, cause processor 802 to effectuate operations associated with diagnostic testing.

While the disclosed systems have been described in connection with the various examples of the various figures, it is to be understood that other similar implementations may be used, or modifications and additions may be made to the described examples of a diagnostic system without deviating therefrom. For example, one skilled in the art will recognize that a diagnostic system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—handling and transporting diagnostic samples—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. A drawer apparatus comprising:
a body configured to form a sample receiving compartment for housing a diagnostic sample;
a gear rack directly affixed to the body and meshing with a drive mechanism;
a constant force spring mechanism coupled with the gear rack;
a rotary damper;
a latch solenoid; and
a drawer closed sensor.

2. The apparatus of claim 1, wherein the drive mechanism induces a regulated linear motion of the drawer in response to engagement with the gear rack.

3. The apparatus of claim 1, wherein the constant force spring uniformly modulates a retraction force of the drawer.

4. The apparatus of claim 1, wherein the rotary damper dampens kinetic energy associated with a movement of the drawer.

5. The apparatus of claim 1, wherein the latch solenoid selectively maintains the drawer in a secure closed state within a diagnostic device.

6. The apparatus of claim 1, wherein the drawer closed sensor verifies a containment of the diagnostic sample.

7. The apparatus of claim 1, wherein the linear guide facilitates bi-directional movement of the drawer along a defined pathway.

8. The apparatus of claim 1, wherein the constant force spring mechanism is enclosed within a casing affixed to the body, wherein the casing protects the spring mechanism from one or more external environmental factors.

9. The apparatus of claim 1, wherein the rotary damper absorbs kinetic energy associated with an opening movement or a closing movement of the drawer.

10. The apparatus of claim 1, wherein the latch solenoid engages with a diagnostic device.

11. The apparatus of claim 1, wherein the drawer closed sensor transmits a positional state of the drawer to a diagnostic device.

12. The apparatus of claim 1, further comprising an electronic control unit operatively connected to the latch solenoid, rotary damper, and drawer closed sensor, wherein the electronic control unit coordinates opening or closing of the drawer.

13. A system, comprising:
a memory; and
at least one computing device in communication with the memory, the at least one computing device being configured to at least:
open a drawer of a diagnostic device;
receive, by the drawer, a cartridge housing a diagnostic sample;
retract the drawer into the diagnostic device;
verify, by a sensor, the cartridge is contained in the diagnostic device; and
secure the drawer into the diagnostic device using a latch solenoid.

14. The system of claim 13, wherein the at least one computing device is further configured to modulate a retraction force of the drawer using a constant force spring.

15. The system of claim 14, wherein the constant force spring mechanism is enclosed within a casing affixed to the body, wherein the casing protects the spring mechanism from one or more external environmental factors.

16. The system of claim 13, wherein the at least one computing device is further configured to program operational parameter of the drawer.

17. The system of claim 13, wherein a linear guide facilitates bi-directional movement of the drawer along a defined pathway.

18. A method comprising:
opening a drawer of a diagnostic device;
receiving, by the drawer, a cartridge housing a diagnostic sample;
retracting the drawer into the diagnostic device;
verifying, by a sensor, the cartridge is contained in the diagnostic device; and
securing the drawer into the diagnostic device using a latch solenoid.

19. The method of claim 18, further comprising modulating a retraction force of the drawer using a constant force spring.

20. The method of claim 18, further comprising programming an electronic control unit for customization of a plurality of operational parameters of the drawer.
